(19) United States
(12) Patent Application Publication
(10) Pub. No.: US 2007/0156592 A1
(43) Pub. Date: Jul. 5, 2007

(54) SECURE AUTHENTICATION METHOD AND SYSTEM

(75) Inventor: Grant Patrick Henderson, Dunlop (AU)

Correspondence Address: MICHAEL BEST & FRIEDRICH, LLP, ONE SOUTH PINCKNEY STREET, P O BOX 1806, MADISON, WI, 53701, US

(73) Assignee: Reality Enhancement Pty Ltd, Deakin (AU)

(21) Appl. No.: 11/615,044

(22) Filed: Dec. 22, 2006

(30) Foreign Application Priority Data
Dec. 22, 2005 (AU) 2005 907244

(51) Int. Cl. G06Q 99/00

(52) U.S. Cl. 705/51

(57) ABSTRACT

An automated method for authenticating a customer with a vendor, the method including the steps of (a) the customer nominating a remote authentication agent, (b) the customer identifying themselves by transmission of customer credentials to the authentication agent via a network connection, (c) the vendor identifying themselves by transmission of vendor credentials to the authentication agent, and (d) the authentication agent providing credentials for the customer to the vendor so that the vendor can perform authentication as a prerequisite to permitting direct communication between the vendor and customer through the network.

### FIELD OF THE INVENTION

The present invention relates to a system and methods for authenticating a user with a vendor via a communications network, and in particular, but not being limited to, authenticating a user via a remote authentication server.

### BACKGROUND OF THE INVENTION

In this specification where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

Electronic transaction via a communications network, e.g. to purchase goods or services, may require customers to identify themselves by providing the vendor with credentials for authentication. Authentication typically involves each customer providing their credentials such as a user name, password, pin number or other type of identifier that is unique to (or is only known by) the customer.

Vendors may require customers to provide a user name and password before for conducting an online and/or offline transaction. Customers may be required to provide additional credentials. Customers therefore need to remember numerous authentication credentials in order to engage in transactions with different vendors. Because of this, customers tend to use the same authentication credentials when dealing with different vendors. If the security of one vendor's system is compromised, this may compromise the security of other vendor systems where the customer has used the same credentials.

A number of systems have been proposed for managing authentication processes, such as a universal user identifier and password management system for Internet connected devices as described in U.S. Pat. No. 6,859,878 (to IBM), a method and system for secure pervasive access as described in U.S. Pat. No. 6,859,879 (to IBM), and authentication methods and systems for accessing networks and authentication methods and systems for accessing the Internet as described in U.S. Pat. No. 6,834,341 (to Microsoft).

Other attempts to solve this problem including providing customers with a single-sign-on (SSO) service. A customer is provided with a set of SSO authentication credentials unique to the customer. To access a vendor service, the customer uses a client computer to provide SSO authentication credentials to an SSO authentication server. Once the server authenticates the customer, the SSO authentication server sends vendor-service specific authentication credentials to the client computer, which may be encrypted. The client machine automatically receives and decrypts the vendor-service specific credentials from the authentication server, and submits data including these credentials to the vendor server to authenticate the customer with that vendor service.

A typical SSO authentication service has several problems, for example:
i) the system assumes that the customer's client computer is trustworthy. This assumption may be incorrect because many monitoring tools exist that permit thieves to capture information on standard output devices (such as a display monitor) and input devices (such as keyboards and mice). Credentials passed between the SSO server and the customer can be intercepted (e.g. on the customer computer) after decryption has occurred;
ii) the system may require the installation of special software on the customer computer, such as a Java applet, so that the customer computer can communicate with the authentication server and the vendor server; and
iii) authentication servers are generally limited to large organisations that can afford the infrastructure and support to maintain them.

Another approach to solving the problems associated with customer management of authentication involves building trust relationships between vendors and/or one or more authentication service providers. For example, when a customer authenticates with one vendor, those credentials can then be passed to another vendor as a single authenticated session. A common implementation of this technology is known as Microsoft Passport. This solution has several problems, including:
i) a requirement that vendors establish trust relationships between each other or a common authentication provider. These relationships can involve complex technology and ultimately be an expense that only big corporations can afford; and
ii) a requirement for competitors to form trust relationships with regard to customer authentication credentials and other confidential information. In the competitive market place this is unlikely to occur. For example, large financial institutions guard their customer lists jealously and are unlikely to want to share customer details either directly or through an independent authentication provider. This would require that customers trust the authentication relationship between vendors. Furthermore sharing of customer details may raise legal privacy issues in many jurisdictions.

Existing authentication systems and methods typically rely on trust relationships between an authentication provider and one or more vendors but this arrangement is not ideal. It is desired to address one or more of the above problems (e.g. by moving the trust relationship into the control of the customer), or to at least provide a useful alternative.

### SUMMARY OF THE INVENTION

The present invention provides a system for authenticating a customer with a vendor through a remote authentication agent nominated by the customer.

The present invention also provides an automated method for authenticating a customer with a vendor, the method including the steps of:
i) the customer nominating a remote authentication agent,
ii) the customer identifying themselves by transmitting customer credentials to the authentication agent via a network connection,
iii) the vendor identifying themselves by transmitting vendor credentials to the authentication agent, and
iv) the authentication agent providing credentials for the customer to the vendor so that the vendor can perform authentication as a prerequisite to permitting direct communication between the vendor and customer through the network.

An advantage of the present invention is that, unlike authentication methods that rely on trust relationships between an authentication provider and/or one or more vendors, the methods described herein builds trust relationships between a customer and the authentication agent without the involvement of the vendor. Unlike authentication methods of the prior art which are vendor driven, the method of the present invention is customer driven. Furthermore the methods do not rely on a trust relationship between vendor and authentication provider (e.g. in Microsoft Passport).

The present invention also provides an automated system for authenticating a customer with a vendor, comprising:
(a) an authentication agent server,
(b) one or more remote customer terminals located in a customer location,
(c) one or more remote vendor terminals located in a vendor location, wherein the server,
(i) receives customer credentials from the remote customer terminal,
(ii) receives vendor credentials from the remote vendor terminal, and subsequently,
(iii) communicates the customer credentials to the vendor terminal so that the vendor can perform authentication as a prerequisite to permitting direct communication between the vendor and customer through a network.

The present invention also provides a method of facilitating authentication of a customer by a vendor comprising the steps of,
i) communicating customer nomination of a remote authentication agent from one or more remote customer terminals to the authentication agent,
ii) communicating identification credentials from one or more remote customer terminals to the authentication agent,
iii) communicating identification credentials from one or more remote vendor terminals to the authentication agent, and
iv) communicating customer credentials to the one or more vendor terminals so that the vendor can perform authentication as a prerequisite to permitting direct communication between the vendor and customer through the network.

The present invention may further comprise the steps of communicating whether or not the vendor has been successful in satisfying the criteria for the authentication process.

The present invention may be used for authentication through a server, comprising,
i) receiving customer nomination of a remote authentication agent from one or more remote customer terminals,
ii) receiving identification credentials from one or more remote customer terminals,
iii) receiving identification credentials from one or more remote vendor terminals, and
iv) receiving notification from the one or more vendor terminals regarding the success (or otherwise) of customer compliance with the criteria for the authentication process and whether direct communication is permitted between the vendor and customer through a network.

### BRIEF DESCRIPTION OF THE DRAWINGS

Preferred embodiments of the present invention are herein described, by way of example only, with reference to the accompanying drawings, wherein:

FIG. 1 is a block diagram of an authentication system;

FIG. 2 is a flow diagram of a first authentication process;

FIG. 3 is a flow diagram of a second authentication process;

FIG. 4 is a flow diagram of a third authentication process;

FIG. 5 is a flow diagram of a fourth authentication process.

FIG. 6 is a block diagram of the system configured for performing the first authentication process;

FIG. 7 is a block diagram of the system configured for performing the second authentication process;

FIG. 8 is a block diagram of the system configured for performing the third authentication process; and

FIG. 9 is a block diagram of the system configured for performing the fourth authentication process.

### DETAILED DESCRIPTION OF THE PREFERRED EMBODIMENTS

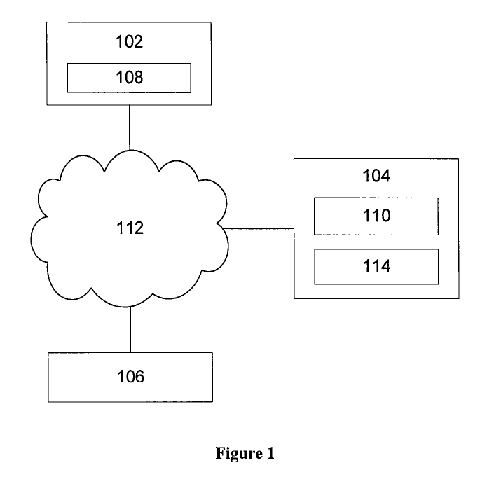

An authentication system 100, as shown in FIG. 1, includes a client computer 102, an authentication server 104 and a vendor server 106 which communicate with each other via a communications network 112, such as one or more wired or wireless networks (e.g. 802.11 b/g, Bluetooth the Internet). The client computer 102 may be a processor incorporated into a mobile phone, a public kiosk computer terminal, or a standard computer (e.g. that provided by IBM Corporation <http://www.ibm.com>) running a standard operating system (such as Microsoft Windows™, Unix, Linux or Apple OS X). The vendor server 106 is a standard web server (e.g. a standard computer configured to run Apache <http://www.apache.org>) providing access to a network service (e.g. an online email service) to authenticated users.

The client computer 102 includes a communications module 108 that (e.g. under the control of a user) generates request messages for sending to, and processes response messages received from, the authentication agent module 108 and the vendor server 106 via the network 112. The communications module 108 may be a web browser application running on the computer 102 (e.g. Microsoft Internet Explorer™, Netscape Navigator, Mozilla Firefox or Apple Safari). The system is more accessible to users by not requiring special software to be installed in order for authentication to occur (in contrast to existing single sign-on services). The request/response messages generated by the system 100 may be in the Hypertext Transfer Protocol (HTTP) or any other communications protocol, such as a schema-based or XML data communications protocol), and these messages may be encrypted using a Secure Sockets Layer (SSL), Transport Layer Security (TLS) or other encryption mechanism (preferably using at least 128-bit encryption).

The authentication server 104 is a standard web server including an authentication agent module 110 and a database 114. The module 110 and database 114 are stored in the memory of the authentication server 104. The memory includes one or more physical data storage media (e.g. a hard disk), random access memory (RAM) and/or read-only memory (ROM). The authentication server 104 sends and receives request/response messages via the network 112. The database 114 may include a relational database (such as MySQL <http://www.mysql.org>), a symbol-delimited file and/or a hash table.

The processes performed by the communications module 108 and authentication agent module 110 are preferably implemented in software and executed by the client computer 102 and authentication server 104 respectively. Those skilled in the art will appreciate that the processes performed by the modules 108 and 110 can be executed, at least in part, by dedicated hardware circuits, e.g. Application Specific Integrated Circuits (ASICs) or Field-Programmable Gate Arrays (FPGAs).

A user operates the client computer 102 to control the communications module 108 to send user login data to the authentication agent module 110 for authenticating the user. The authentication agent module 1 10 processes the user login data using a two-stage authentication process, where each stage uses different user identification credentials derived from the user login data. The first stage of the authentication process involves the authentication agent module 110 analysing primary identification data in the user login data. The primary identification data may represent a password known only to the user. If the user is authenticated after the first stage, the authentication agent module 110 analyses secondary identification data in the user login data. The secondary identification data may represent a key identifier unique to the user. A key identifier may be automatically generated by a one-time password device (e.g. a RSA SecureID token, Vasco Digipass or ActivCard Token). Alternatively, the secondary identification data may include an identifier stored on a personal smart card, or one or more identifiers generated based on the user's biometric attributes, e.g. by fingerprint readers or retinal scanners.

The authentication agent module 110 may be configure to perform additional processing (e.g. to perform a Completely Automated Public Turing testing process to tell Computers and Humans Apart (CAPTCHA) that involves generating challenge and receiving a response to the challenge to determine whether the response is from a human) that enables the module 110 to distinguish between authentication requests from human users and other types of requests, such as those generated automatically by a computer posing as users (similar to a Denial of Service attack). This minimises the processing of illegitimate requests that block legitimate user requests to authenticate with the module 110.

After the user has been authenticated by the authentication agent module 110, the user selects a vendor identifier to access a vendor server. The authentication server 104 retrieves the user's user authentication data from the database 114, and communicates directly with the selected vendor server on behalf of the user (e.g. to initiate authentication of that user). This enhances the protection and security of a user's authentication credentials since users do not have to reuse authentication credentials for different vendors, or store the credentials in a way that is easily accessible or disclosed. Each vendor identifier is associated with connection data and user authentication data. Connection data represents the network location (e.g. a Universal Resource Locator (URL)) for accessing a selected vendor server via the network 112. User authentication data represents one or more credentials for authenticating the user with the vendor server.

The authentication agent module 110 may be implemented as several vendor modules, where each vendor module includes code and/or instructions for controlling the authentication agent module 110 to authenticate a user with a particular vendor server. Connection data for each vendor server may be represented by the code/instructions in each vendor module. Alternatively, connection data for each vendor may be stored in the database 114 and retrieved for use by the relevant vendor module when required. In operation, for example, each vendor module controls how the user authentication data for a user is inserted into a webpage authentication form and how additional user information is included on the form before submission to the vendor server. Vendors may modify the authentication form for accessing their servers. Accordingly, the authentication agent module 110 may perform steps to determine whether the authentication form received from a vendor server is current. If there are changes to the authentication form, the authentication agent module 110 generates an alert message (e.g. an email to the relevant website administrator or developers) so that the code/instructions in the relevant vendor module can be modified and tested as necessary.

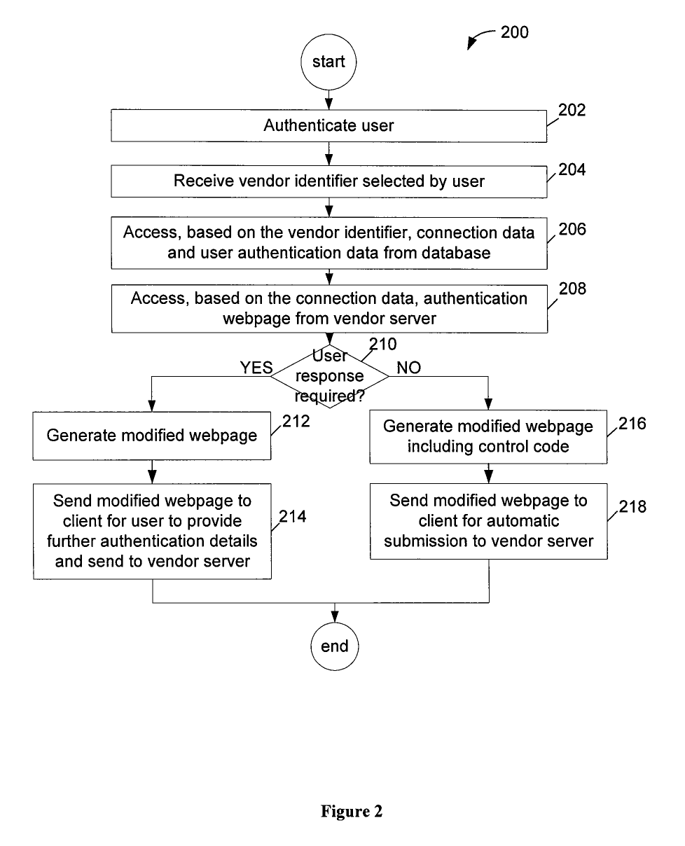

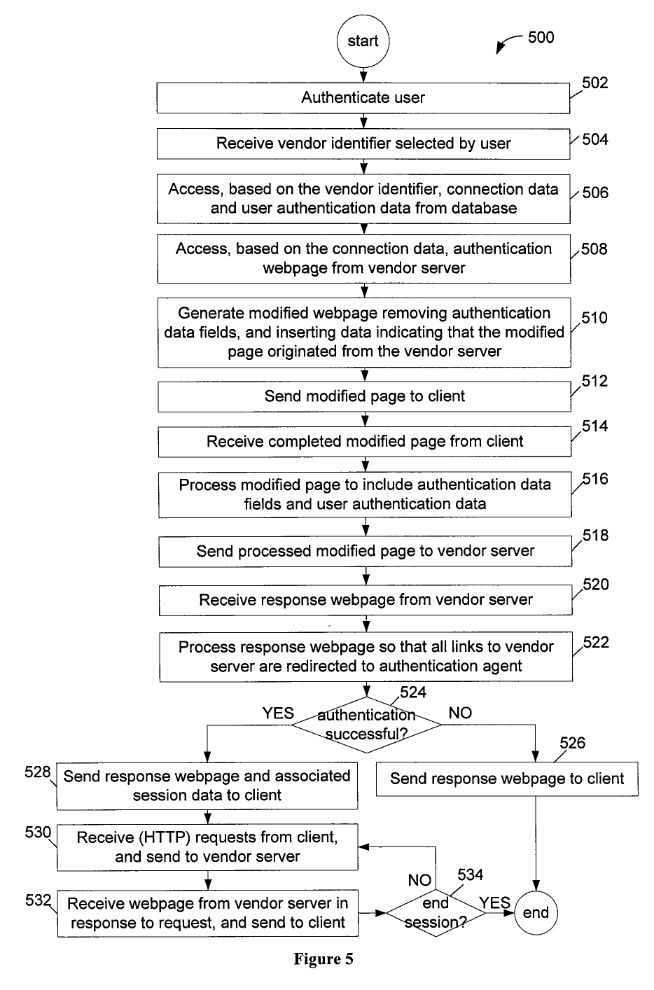

The authentication agent module 110 performs an authentication process with the selected vendor server 106, as herein described with reference to FIGS. 2 to 5. Each of the processes described in FIGS. 2 and 5 attempts to provide a more secure way of authenticating users over the network 112. The authentication server 104 initially sends a request message to the vendor server 106 to retrieve an authentication webpage (from the server 106) that includes a form having one or more data fields for providing a user's user authentication data. If the authentication webpage does not require input specifically from the user (e.g. in response to a question on the authentication webpage), the authentication agent module 110 generates a request message representing a modified version of the authentication webpage including the user's user authentication data. The authentication server 104 sends the request message to the vendor server 106. The authentication module 110 may perform additional processes including removing or replacing a vendor's identification data (or credentials) from the authentication webpage and other forms of data manipulation.

The vendor server 106 performs an independent authentication process. Each vendor server 106 may implement a different authentication process, and successful authentication with the relevant vendor server 106 is a prerequisite to permitting direct communication between the vendor and user via the network 112. If the vendor server 106 receives a modified authentication webpage from the authentication server 104 that complies with the requirements of the vendor's authentication process, the server 106 generates and sends a response message including data representing a response webpage to the authorisation agent module 110. The response message may include session data that identifies a communications session between the servers 104 and 106. The session data may be included as a hidden data field in the response webpage, or alternatively, included in a cookie sent with the response webpage. The authorisation agent module 110 may generate and send a notification webpage to the client 102 confirming successful authentication, or alternatively, forward the response webpage to the client 102.

If the completed authentication webpage form does not comply with the requirements of the vendor's authentication process, the vendor server 106 generates a response message representing an error response webpage and sends this to the authentication agent module 110. The error response webpage may include suggestions for actions that a user could perform to comply with the vendor's authentication requirements. Either the user or the authentication agent module 110 could take action in response to the error response webpage and amend the form included in the webpage. The resubmitted form could then be resubmitted to the vendor to again be subjected to the authentication process.

1. Customer Authentication with the Vendor Via the Customer

FIG. 2 is a flow diagram of the steps in a first authentication process 200 for execution by the authentication agent module 110. The authentication process 200 is more suitable for client computers 102 that are considered trustworthy. Process 200 begins at step 202 where the user (e.g. using the client computer 102) forwards user login data to the authentication server 104. If the user is authenticated by the server 104, the server 104 generates an options webpage that allows the user to select (e.g. from options in a drop down menu) a vendor identifier representing the vendor server which the user requires access, and the client 102 forwards the selected vendor identifier to the authentication server 104 . At step 204, the authentication agent module 110 receives the selected vendor identifier. At step 206 the authentication agent module 110 retrieves from the database 114, based on the vendor identifier, connection data and user authentication data for the selected vendor server 106. At step 208, the authentication agent module authentication server 104 generates and sends a request message to the selected vendor server 106 based on the connection data, and receives an authentication webpage from the vendor server 106.

At step 210, the authentication agent module 110 determines whether the authentication webpage includes data fields that require a user to enter authentication credentials not represented by the user's user authentication data from the database 114. For example, the authentication webpage may include data input fields (e.g. HTML <INPUT> fields) that require users to provide input representing a one-time password or a response to a CAPTCHA-type query, which may involve the user entering a string of characters corresponding to the characters displayed in a graphical image on the webpage .

If step 210 determines that no additional user input is required by the vendor server 106, step 210 proceeds to step 216 where the authentication agent module 110 generates a modified webpage based on the authentication webpage. The modified webpage generated at step 216 includes the user's user authentication data as data values in the appropriate data input fields of the modified webpage (e.g. by coding the credentials as a data value in an HTML <INPUT> data field). The data input fields may be modified so that the actual fields and/or their data values are not displayed by the communications module 108 (e.g. by setting the TYPE attribute of <INPUT> fields containing user authentication data to “hidden” or “password”). The modified webpage generated at step 216 may include control code and/or instructions (e.g. code written in Javascript) that, when accessed by the communications module 108, causes the module 108 to automatically forward the modified webpage to the vendor server 106. At step 218, the authentication server 104 sends the modified webpage to the client 102 for access by the communications module 108. The communications module 108 then automatically forward the modified webpage to the vendor server 106 (if controlled by the control code), or alternatively, the user may control the communications module 108 (e.g. by clicking on a submit button) to send the modified webpage to the vendor server 106.

If step 210 determines that additional user input is required by the vendor server 106, step 210 proceeds to step 212 where the authentication agent module 110 generates a modified webpage based on the authentication webpage. The modified webpage generated at step 212 is similar to the modified webpage generated at step 216, except that it has additional data input fields for the user to provide input representing a response as required by the vendor server 106 (e.g. a response to a predetermined question). The modified webpage does not include control code that controls the communications module 108 to automatically submit the modified webpage to the vendor server 106. At step 214, the authentication server 104 sends the modified webpage to the client 102 for access by the communications module 108. The user then provides input into the additional data input fields to respond to the vendor server 106, and sends (e.g. by clicking on a submit button) the modified webpage with the data values to the vendor server 106.

Process 200 ends after steps 214 or 218. However, following steps 214 and 218, the vendor server 106 authenticates the user based on the user authentication data and/or the data in the additional data input fields. If authentication by the server 106 is successful, the server 106 communicates directly with the client computer 102.

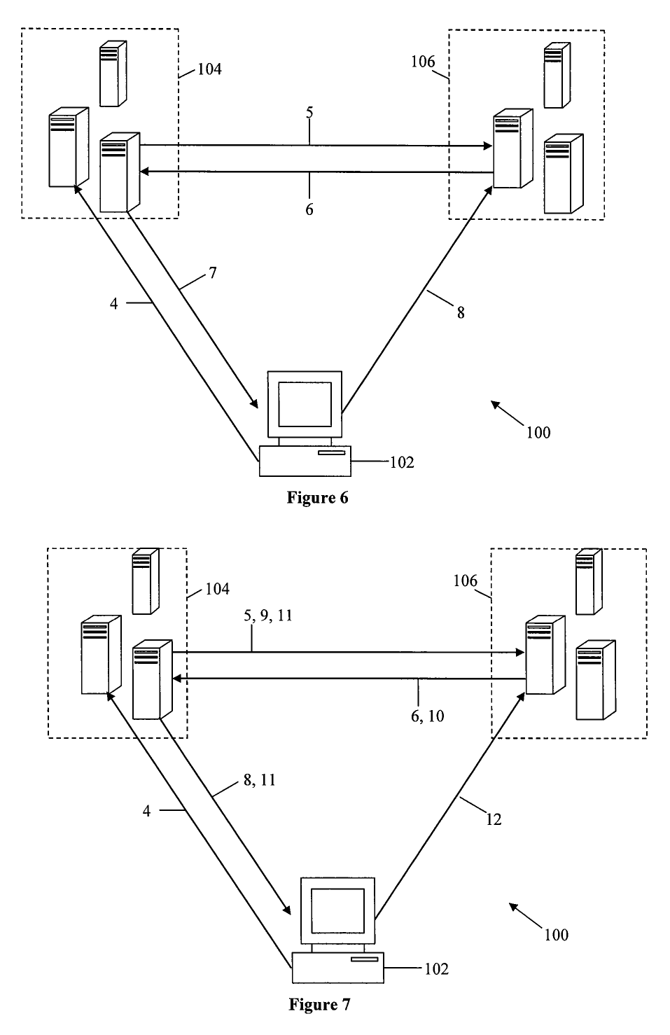

FIG. 6 is a block diagram of the authentication system 100 when the authentication agent module 110 is configured to perform process 200. The arrows in FIG. 6 indicate the direction data transmissions between the client computer 102, the authentication server 104 and/or the vendor server 106 at different points in time (as indicated by reference numbers 4 to 8). As shown in FIG. 6, the vendor server 106 generates an authentication webpage including a form having authentication data fields. The authentication webpage is then forwarded to the client computer 102 (e.g. for access by the communications module 108).

At time period 4, the user of the client computer 102 nominates a remote authentication server 104 (e.g. based on a selection representing one of several predetermined authentication servers). The user controls the client computer 102 to forward user authentication data (e.g. representing customer credentials) to the selected authentication server 104 via the network 112. The authentication agent module 110 of the selected server 104 obtains a user selection of a particular vendor server 106 from the client 102, and retrieves an authentication webpage from the selected vendor server 106.

At time period 5, the authentication agent requesting the authentication form from the vendor.

At time period 6, the vendor server 106 provides to the authentication agent module 110 an authentication webpage. The authentication agent module 110 then receives the authentication webpage requested. The module 110 inserts user authentication data (e.g. representing the user's authentication credentials) into appropriate fields of the form in the authentication webpage received and:
(i) optionally inserting computer code (such as JavaScript) into the authentication form, the code causing the page to be automatically submitted to the Vendor,
(ii) makes other modifications to the authentication form as necessary, such as providing additional information required by the form, and
(iii) alters HTML INPUT tags TYPE attributes to “hidden” or “password” so that fields are no longer visible to the customer.

At time period 7, the authentication agent module 110 sends the authentication webpage modified as mentioned above to the client computer 102 via a network 112.

At time period 8, the user provides input to the relevant authentication data fields of the authentication webpage, and submits the authentication webpage to the vendor server 106 for the server 106 to perform authentication as a prerequisite to permitting direct communication between the vendor server 106 and client computer 102 through the network 112.

Typically the authentication form from the vendor is a web page or other electronic method for collecting information. Typically the vendor authentication form is returned to the customer's network browser, such as an internet browser. The customer network browser may, for example,
(i) Display the authentication form and automatically execute any computer code inserted by the authentication agent and submit the customer credentials to the vendor; or
(ii) Display the authentication form and wait for additional input required by the vendor such as general information, CAPTCHA's or one time passwords.
   2. Customer Authentication with the Vendor without Customer Disclosure

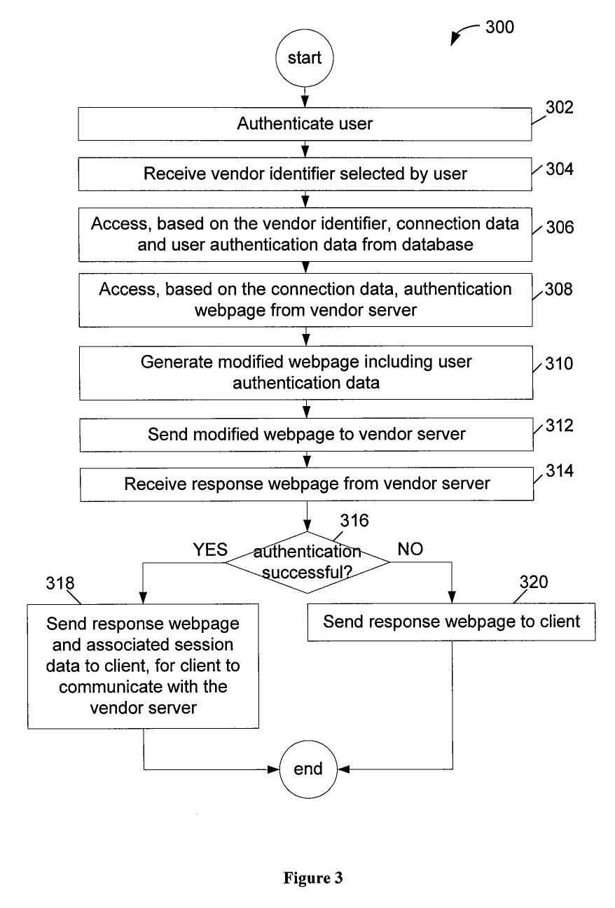

FIG. 3 is a flow diagram of the steps in a second authentication process 300 for execution by the authentication agent module 110. The second authentication process 300 is suited to client computers 102 that the user considers to be untrustworthy (e.g. computers in an internet kiosk). The second authentication process 300 is similar to the first authentication process 200 but removes the need to forward customer authentication credentials back to the customer, thereby eliminating the possibility of interception on the client computer 102. Instead, the authentication agent module 110 authenticates directly with the vendor server 106 on behalf of the user and then forwards session details back to the communications module 108 (e.g. an internet browser).

Process 300 begins at step 302 where the user forwards user login data to the authentication server 104. If the user is authenticated by the server 104, the server 104 generates an options webpage that allows the user to select a vendor identifier representing the vendor server which the user requires access, and the client 102 forwards the selected vendor identifier to the authentication server 104. At step 304, the authentication agent module 110 receives the selected vendor identifier. At step 306 the authentication agent module 110 retrieves from the database 114, based on the vendor identifier, connection data and user authentication data for the selected vendor server 106. At step 308, the authentication agent module authentication server 104 generates and sends a request message to the selected vendor server 106 based on the connection data, and receives an authentication webpage from the vendor server 106.

At step 310, the authentication agent module 110 generates a modified webpage based on the authentication webpage received from the vendor server 106. The modified webpage includes the user's user authentication data as data values in the appropriate data input fields of the modified webpage (e.g. by coding the credentials as a data value in an HTML <INPUT> data field). The data input fields may be modified so that the actual fields and/or their data values are not displayed by the communications module 108 (e.g. by setting the TYPE attribute of <INPUT> fields containing user authentication data to “hidden” or “password”). At step 312, the authentication server 104 sends the modified webpage to the vendor server 106. The vendor server 106 processes the user authentication data included in the modified webpage client 102 to authenticate the user for accessing data on the vendor server 102. At step 314, the vendor server 106 sends a response webpage to the authentication server 104. If authentication by the vendor server 106 is successful, the response webpage will include session data in a session variable message (e.g. in a cookie). Otherwise, authentication is unsuccessful and the response webpage includes an error message.

At step 316, the authentication agent module 110 analyses the response webpage to determine whether the user was successfully authenticated by the vendor server 106. If so, at step 318, the authentication server 104 sends the response webpage together with the associated session data to the client computer 102, which enables the client computer 102 (e.g. via the communications module 108) to communicate with the vendor server 106. Otherwise, at step 318, the authentication server 104 sends the response webpage (including the error message) to the client 102. Process 300 ends after step 318 or 320.

FIG. 7 is a block diagram of the authentication system 100 when the authentication agent module 110 is configured to perform process 300. The arrows in FIG. 7 indicate the direction of data transmissions between the client computer 102, the authentication server 104 and/or the vendor server 106 at different points in time (indicated by reference numerals 4 to 12).

At time period 4, a user selects a remote authentication server 104 using the communications module 108 of the client computer 102. The user uses the communications module 108 to send user identification data (representing the user's authentication credentials) to the authentication server 104 via a network connection (but only if the user has not provided user authentication data to the authentication server 104). Furthermore, the user uses the communications module 108 to control the authentication agent module 110 to retrieve the user's user authentication data stored on the authentication server 104 for authentication with a selected vendor server 106.

At time period 5, the authentication agent module 110 sends a request to the vendor server 106 to retrieve an authentication webpage.

At time period 6, the vendor server 106 sends an authentication webpage to the authentication agent module 110 of the authentication server 104, the authentication webpage including authentication data input fields. The authentication agent module 110 receives the authentication webpage. The authentication agent module 110 generates a modified webpage by inserting the user's user authentication data into the authentication webpage.

At time period 9, the authentication agent module 110 makes other modifications to the modified webpage (as necessary) including providing additional information required by the authentication webpage. The authentication agent module 110 submits the completed modified webpage to the vendor server 106 for to the vendor server 106 to perform authentication of the user as a prerequisite to permitting direct communication between the vendor server 106 and user (via the client 102) through the network 112.

At time period 10, the vendor server 106 generates and sends a notification (e.g. a response webpage) to the authentication agent module 110 that indicates the outcome of the authentication attempt.

At time period 11, the authentication agent module 110 processes the notification from the vendor server 106. If the vendor server 106 does not successfully authenticate the user, the authentication webpage returned to the customer computer with an error message, optionally with suggestions to overcome the error. If the vendor server 106 successfully authenticates the user, the authentication form and session variable being returned to the client computer 102, the session variable optionally embedded in the form or included as a cookie so (e.g. at time period 12) that the client computer 102 can communicate directly with the vendor server 106.

3. Customer Authentication with Vendor with Partial Customer Completion

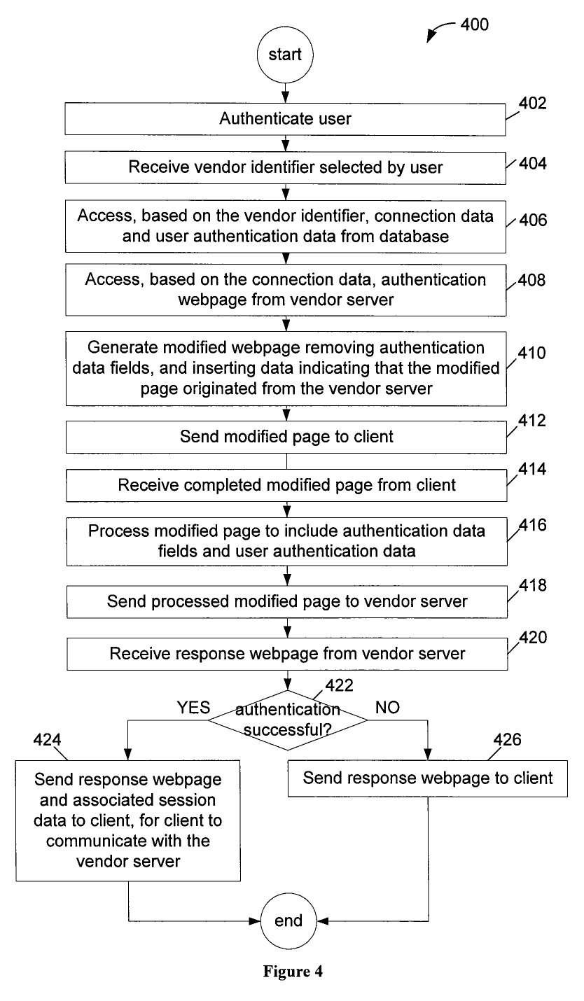

FIG. 4 is a flow diagram of the steps in a third authentication process 400 for execution by the authentication agent module 110. The third authentication process 400 is suited to client computers 102 that are untrustworthy but where additional information is required that can not be provided using the second authentication process 300. The third authentication process 400 provides greater security in comparison to the first and second authentication processes 200 and 300 by introducing the need to capture additional information from the user prior to authentication with the vendor server 106.

Process 400 begins at step 402 where the user provides user login data to the authentication server 104. If the user is authenticated by the server 104, the server 104 generates an options webpage that allows the user to select (e.g. from options in a drop down menu) a vendor identifier representing the vendor server which the user requires access, and the client 102 forwards the selected vendor identifier to the authentication server 104. At step 404, the authentication agent module 110 receives the selected vendor identifier. At step 406 the authentication agent module 110 retrieves from the database 114, based on the vendor identifier, connection data and user authentication data for the selected vendor server 106. At step 408, the authentication agent module authentication server 104 generates and sends a request message to the selected vendor server 106 based on the connection data, and receives an authentication webpage from the vendor server 106.

At step 410, the authentication agent module 110 generates a modified webpage based on the authentication webpage. The modified webpage does not include (or prevents from being displayed) data input fields from the authentication webpage for the user to provide authentication credentials. The modified webpage also includes data indicating (e.g. to the client computer 102 when it receives the modified webpage) that the modified webpage originated from the vendor server 106, for example, by changing the source Internet Protocol (IP) addresses of data packets sent by the authentication server 104 for transmitting the modified webpage to the client computer 102. The modified webpage may include data input fields (e.g. HTML <INPUT> fields) that require users to provide input representing a response to a CAPTCHA-type query, a one-time password or other session specific data that cannot be provided in an automated manner.

At step 412, the authentication server 104 sends the modified webpage to the client 102 for access by the communications module 108. The user (via the communications module 110) provides input into the relevant data input fields where available or required. At step 414, the authentication server 104 receives the modified webpage (including the user's input) from the client computer 102. At step 416, the authentication agent module 110 processes the modified webpage to include the user's user authentication data in the relevant data input fields. At step 418, the authentication server 104 sends the modified webpage (with the user's inputs and user authentication data) to the vendor server 106. The vendor server 106 then attempts to authenticate the user based on the user's additional user input (to the CAPTCHA-type query etc.) and user authentication data. If authentication by the vendor server 106 is successful, the response webpage will include session data in a session variable message (e.g. in a cookie). Otherwise, authentication is unsuccessful and the response webpage includes an error message.

At step 422, the authentication agent module 110 analyses the response webpage to determine whether the user was successfully authenticated by the vendor server 106. If so, at step 424, the authentication server 104 sends the response webpage together with the associated session data to the client computer 102, which enables the client computer 102 (e.g. via the communications module 108) to communicate with the vendor server 106. Otherwise, at step 426, the authentication server 104 sends the response webpage (including the error message) to the client 102. Process 400 ends after step 424 or 426.

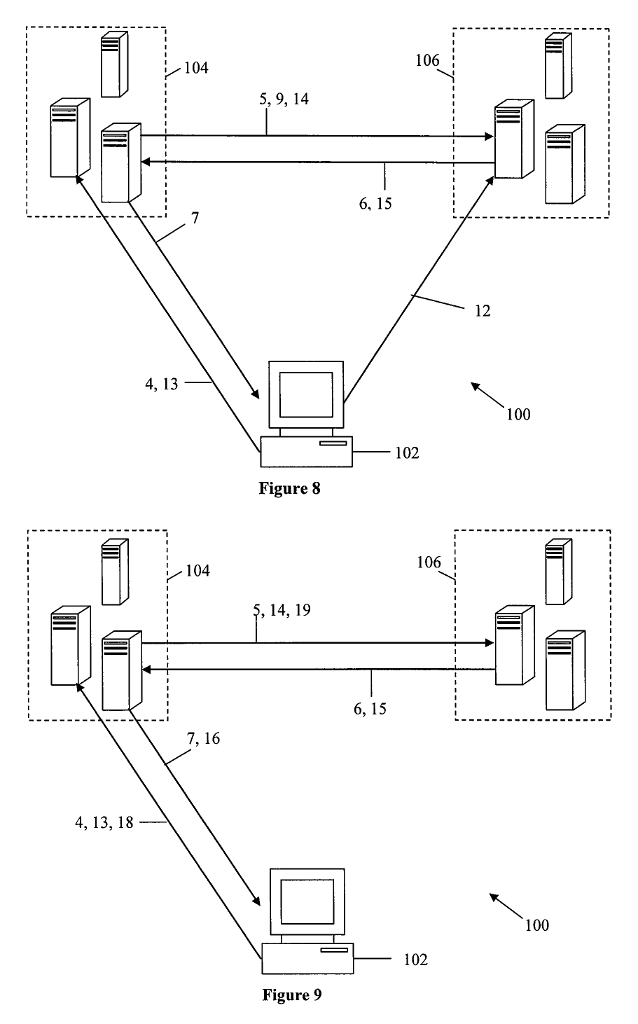

FIG. 8 is a block diagram of the authentication system 100 when the authentication agent module 110 is configured to perform process 400. The arrows in FIG. 8 indicate the direction of data transmissions between the client computer 102, the authentication server 104 and/or the vendor server 106 at different points in time (indicated by reference numerals 4 to 15).

At time period 4, a user selects a remote authentication server 104 using the communications module 108 of the client computer 102. The user uses the communications module 108 to send user identification data (representing the user's authentication credentials) to the authentication server 104 via a network connection (but only if the user has not provided user authentication data to the authentication server 104). Furthermore, the user uses the communications module 108 to control the authentication agent module 110 to retrieve the user's user authentication data stored on the authentication server 104 for authentication with a selected vendor server 106.

At time period 5, the authentication agent module 110 sends a request to the vendor server 106 to retrieve an authentication webpage.

At time period 6, the vendor server 106 sends an authentication webpage to the authentication agent module 110 of the authentication server 104, the authentication webpage including authentication data input fields. The authentication agent module 110 receives the authentication webpage, and the authentication agent module 110 modifies the authentication webpage by removing certain data input fields. The fields removed initially by the authentication agent module 110 may be automatically returned by the authentication agent module 110 in later steps, and are not required for completion by the user. The fields that remain will typically include session-specific information that cannot be easily automated, such as HTTP session identifiers or one-time passwords. The modified webpage also includes data to make it appear to the user (e.g. when accessed using the communications module 108) that the authentication webpage originated from the vendor server 106.

At time period 7, the authentication agent generates a modified webpage based on the authentication webpage, and sends the modified webpage to the client computer 102 for the user to provide the necessary input data.

At time period 13, the user provides the required data to complete the modified webpage and returns the same to the authentication server 104, and the authentication agent module 110 accepts the data provided by the user and includes user authentication data into the data input fields that were previously removed.

At time period 14, the authentication agent module 110 submits the modified webpage (including the user's additional input and user authentication data) to the vendor server 106 for the vendor server 106 to authenticate the user as a prerequisite to permitting direct communication between the client computer 102 and the vendor server 106 via the network 112.

At time period 15, the vendor server 106 generates and sends a response webpage to the authentication server 104 that indicates the outcome of the user authentication attempt. If authentication is successful, the response webpage includes session variable being returned to the authentication agent, optionally with the session variable embedded in the form or included as a cookie so that the client computer 102 can communicate directly with the vendor server 106. If authentication is unsuccessful, the response webpage processed by the authentication agent module 110 will include with an error message (and optionally with suggestions to overcome the error in authenticating the user).

4. Customer Authentication with Vendor Via Authentication Agent (Proxy)

FIG. 5 is a flow diagram of the steps in a fourth authentication process 500 for execution by the authentication agent module 110. The fourth authentication process 500 is suited to client computers 102 that are untrustworthy and where strong security is required. The fourth authentication process 500 is based on authentication processes 200, 300 and 400 but removes all confidential information from the authentication webpage received from the vendor server 106 before forwarding it to the client computer 102.

Process 500 begins at step 502 where the user provides user login data to the authentication server 104. If the user is authenticated by the server 104, the server 104 generates an options webpage that allows the user to select (e.g. from options in a drop down menu) a vendor identifier representing the vendor server which the user requires access, and the client 102 forwards the selected vendor identifier to the authentication server 104. At step 504, the authentication agent module 110 receives the selected vendor identifier. At step 506 the authentication agent module 110 retrieves from the database 114, based on the vendor identifier, connection data and user authentication data for the selected vendor server 106. At step 508, the authentication agent module authentication server 104 generates and sends a request message to the selected vendor server 106 based on the connection data, and receives an authentication webpage from the vendor server 106.

At step 510, the authentication agent module 110 generates a modified webpage based on the authentication webpage. The modified webpage does not include (or prevents from being displayed) data input fields from the authentication webpage for the user to provide authentication credentials. The modified webpage also includes data indicating (e.g. to the client computer 102 when it receives the modified webpage) that the modified webpage originated from the vendor server 106, for example, by changing the source Internet Protocol (IP) addresses of data packets sent by the authentication server 104 for transmitting the modified webpage to the client computer 102. The modified webpage may include data input fields (e.g. HTML <INPUT> fields) that require users to provide input representing a response to a CAPTCHA-type query, a one-time password or other session specific data that cannot be provided in an automated manner.

At step 512, the authentication server 104 sends the modified webpage to the client 102 for access by the communications module 108. The user (via the communications module 110) provides input into the relevant data input fields where available or required. At step 514, the authentication server 104 receives the modified webpage (including the user's input) from the client computer 102. At step 516, the authentication agent module 110 processes the modified webpage to include the user's user authentication data in the relevant data input fields. At step 518, the authentication server 104 sends the modified webpage (with the user's inputs and user authentication data) to the vendor server 106. The vendor server 106 then attempts to authenticate the user based on the user's additional user input (to the CAPTCHA-type query etc.) and user authentication data. If authentication by the vendor server 106 is successful, the response webpage will include session data in a session variable message (e.g. in a cookie). Otherwise, authentication is unsuccessful and the response webpage includes an error message.

At step 522, the authentication agent module 110 processes the response webpage so that all links (e.g. hyperlinks) to the vendor server 106 are redirected to the authentication agent 104, which enables the authentication agent to act as a proxy for communications between the client 102 and the vendor server 106. At step 524, the authentication agent module 110 analyses the response webpage to determine whether the user was successfully authenticated by the vendor server 106. If not, at step 526, the authentication server 104 sends the response webpage (including the error message) to the client 102. Process 500 ends after step 526.

If step 524 determines that authentication was successful, at step 528, the authentication server 104 sends the response webpage together with the associated session data to the client computer 102. At step 530, the authentication server 104 receives requests (e.g. a HTTP request) from the client 102 to communicate with the vendor server 106, and forwards this to the vendor server 106. At step 532, the authentication server 104 receives a response (e.g. a webpage) from the vendor server 106 in response to the request in step 530, and forwards the response to the client 102. Steps 530 and 532 continue until the authentication server 104, at step 534, receives confirmation from either the client 102 or the vendor server 104 to end a communications session between the client 102 and the server 106. If such confirmation is received, process 500 ends.

FIG. 9 is a block diagram of the authentication system 100 when the authentication agent module 110 is configured to perform process 500. The arrows in FIG. 9 indicate the direction of data transmissions between the client computer 102, the authentication server 104 and/or the vendor server 106 at different points in time (indicated by reference numerals 4 to 19).

At time period 4, a user selects a remote authentication server 104 using the communications module 108 of the client computer 102. The user uses the communications module 108 to send user identification data (representing the user's authentication credentials) to the authentication server 104 via a network connection (but only if the user has not provided user authentication data to the authentication server 104). Furthermore, the user uses the communications module 108 to control the authentication agent module 110 to retrieve the user's user authentication data stored on the authentication server 104 for authentication with a selected vendor server 106.

At time period 5, the authentication agent module 110 sends a request to the vendor server 106 to retrieve an authentication webpage.

At time period 6, the vendor server 106 sends an authentication webpage to the authentication agent module 110 of the authentication server 104, the authentication webpage including authentication data input fields. The authentication agent module 110 receives the authentication webpage, and the authentication agent module 110 modifies the authentication webpage by removing certain data input fields. The fields removed initially by the authentication agent module 1 10 may be automatically returned by the authentication agent module 110 in later steps, and are not required for completion by the user. The fields that remain will typically include session-specific information that cannot be easily automated, such as HTTP session identifiers or one-time passwords. The modified webpage also includes data to make it appear to the user (e.g. when accessed using the communications module 108) that the authentication webpage originated from the vendor server 106.

At time period 7, the authentication agent generates a modified webpage based on the authentication webpage, and sends the modified webpage to the client computer 102 for the user to provide the necessary input data.

At time period 13, the user provides the required data to complete the modified webpage and returns the same to the authentication server 104, and the authentication agent module 110 accepts the data provided by the user and includes user authentication data into the data input fields that were previously removed.

At time period 14, the authentication agent module 110 submits the modified webpage (including the user's additional input and user authentication data) to the vendor server 106 for the vendor server 106 to authenticate the user as a prerequisite to permitting direct communication between the client computer 102 and the vendor server 106 via the network 112.

At time period 15, the vendor server 106 generates and sends a response webpage to the authentication server 104 that indicates the outcome of the user authentication attempt. If authentication is successful, the response webpage includes session variable being returned to the authentication agent, optionally with the session variable embedded in the form or included as a cookie so that the client computer 102 can communicate directly with the vendor server 106. If authentication is unsuccessful, the response webpage processed by the authentication agent module 110 will include with an error message (and optionally with suggestions to overcome the error in authenticating the user). The authentication agent module 110 also modifies the links (e.g. hyperlinks or URLs) on the response webpage so that vendor URL's are redirected to an equivalent authentication agent URL's.

At time period 16, if the authentication attempt by the vendor server 106 is successful, the response webpage and session variable is send to the client computer 102. Alternatively, if the authentication attempt by the vendor server 106 is unsuccessful, the response webpage including the error message (preferably including suggestions to overcome the error) is send to the client computer 102.

At time period 18, the customer accepting the response webpage, and if the authentication attempt has been unsuccessful, the customer can amend the authentication webpage or resubmit different authentication credentials for authentication by the vendor server 106. The user controls the client computer 102 to submit the amended authentication webpage to the authentication agent module 110.

At time period 19, the authentication agent module 1 10 receives the amended authentication form and forwarding same to the vendor, these steps being repeated until the authentication attempt is successful or the customer closes down their network connection to the authentication agent.

The authentication fields removed by the authentication agent in the early steps are automatically completed by the authentication server in the later steps and are not required by the customer. The fields that remain will typically include CAPTCHA's, one time password's or other session specific information that can not be automated.

The content of the amended form is irrelevant to the authentication agent because at this point, the authentication agent is only interested in forwarding data between the customer and vendor computers.

The use of a proxy extends the capability of a proxy server to also modify the pages transmitted between customer and vendor. It provides the ultimate level of security by redirecting all traffic via a more secure authentication agent server that is capable of stripping confidential information.

A webpage as described in this specification should be interpreted as including any form of data transmission message in any protocol or format (e.g. including an XML message or appropriately pre-formatted data messages for achieving the same function as the webpages as described herein).

The word ‘comprising’ and forms of the word ‘comprising’ as used in this description and in the claims does not limit the invention claimed to exclude any variants or additions.

Modifications and improvements to the invention will be readily apparent to those skilled in the art. Such modifications and improvements are intended to be within the scope of this invention.

1. An automated method for authenticating a customer with a vendor, the method including the steps of:
(a) the customer nominating a remote authentication agent,
(b) the customer identifying themselves by transmission of customer credentials to the authentication agent via a network connection,
(c) the vendor identifying themselves by transmission of vendor credentials to the authentication agent, and
(d) the authentication agent providing credentials for the customer to the vendor so that the vendor can perform authentication as a prerequisite to permitting direct communication between the vendor and customer through the network.

2. A method as claimed in claim 1, wherein the authentication agent transmits customer credentials to the vendor on behalf of the customer.

3. A method as claimed in claim 1, wherein the customer connects to the authentication agent using a network browser.

4. A method as claimed in claim 3, wherein the customer connects to the authentication agent using a network browser chosen from the group comprising Microsoft Internet Explorer, Netscape Navigator, Mozilla, Firefox or Apple Safari accessed from a computer operating system chosen from the group comprising Microsoft Windows, Linux, Apple OS X or Unix.

5. A method as claimed in claim 1, wherein a connection between the customer and authentication agent occurs over a network.

6. A method as claimed in claim 1, wherein the customer identifies themselves to the authentication agent by a two-step method, each step relying on different identification credentials.

7. A method as claimed in claim 6, wherein the two-step method comprises the customer providing to the authentication agent,
(i) their user name and a secret password, and
(ii) a second form of identification.

8. A method as claimed in claim 1, wherein the vendor identifies themselves by transmitting a vendor authentication form to the authentication agent.

9. A method as claimed in claim 1, wherein the vendor identifies themselves by the authentication agent accessing the vendor authentication form.

10. A method as claimed in claim 1, wherein the customer authentication credentials are stored by the authentication agent in a secure electronic database.

11. A method as claimed in claim 1, wherein the authentication agent inserts at least the customer authentication credentials into a form and sends the completed form back to the vendor.

12. A method as claimed in claim 10 or claim 11, wherein the insertion of customer authentication credentials is carried out automatically by a program in the possession of the authentication agent.

13. A method as claimed in claim 1, wherein successful authentication causes return of a session variable to the authentication agent.

14. An automated system for authenticating a customer with a vendor, comprising:
(a) an authentication agent server,
(b) one or more remote customer terminals located in a customer location,
(c) one or more remote vendor terminals located in a vendor location, wherein the server,
(i) receives customer credentials from the remote customer terminal,
(ii) receives vendor authentication requirements from the remote vendor terminal, and subsequently,
(iii) communicates the customer credentials to the vendor terminal so that the vendor can perform authentication as a prerequisite to permitting direct communication between the vendor and customer through a network.

15. A system as claimed in claim 14, wherein the server also communicates to the authentication agent an indication of whether or not the vendor has successfully complied with the authentication process.

16. A system claimed in claim 14, wherein the server also runs programs for actions chosen from the group comprising inserting customer credentials, removing vendor credentials, replacing vendor credentials in a vendor authentication form.

17. A method of facilitating authentication of a customer by a vendor comprising the steps of:
(a) communicating customer nomination of a remote authentication agent from one or more remote customer terminals to the authentication agent,
(b) communicating identification credentials from one or more remote customer terminals to the authentication agent,
(c) communicating identification credentials from one or more remote vendor terminals to the authentication agent, and
(d) communicating customer credentials to the one or more vendor terminals so that the vendor can perform authentication as a prerequisite to permitting direct communication between the vendor and customer through the network.

18. A method as claimed in claim 17 which further comprises the steps of communicating whether or not the vendor has been successful in satisfying the criteria for the authentication process.

19. A method of facilitating authentication of a customer by a vendor through a server, comprising,
(a) receiving customer nomination of a remote authentication agent from one or more remote customer terminals,
(b) receiving identification credentials from one or more remote customer terminals,
(c) receiving identification credentials from one or more remote vendor terminals, and
(d) receiving notification from the one or more vendor terminals regarding the success (or otherwise) of customer compliance with the criteria for the authentication process and whether direct communication is permitted between the vendor and customer through a network.

20. An automated method for authenticating a customer with a vendor according to claim 1 and as herein described with reference to the drawings.
